(19) United States
(12) Patent Application Publication
(10) Pub. No.: US 2003/0186109 A1
(43) Pub. Date: Oct. 2, 2003

(54) Electrode, membrane electrode assembly, fuel cell and method for their production

(76) Inventors: Wayne Huang, Auburn, AL (US); Leon W. Wu, Auburn, AL (US)

Correspondence Address: Wayne Huang, 2076, S. Evergreen Dr., Auburn, AL, 36830, US

(21) Appl. No.: 10/105,474

(22) Filed: Mar. 26, 2002

(51) Int. Cl. H01M 4/88; H01M 4/94

(52) U.S. Cl. 429/44; 429/30; 427/115; 502/101

(57) ABSTRACT

A method for depositing a nano-structured catalyst coating onto a porous electrode substrate from a precursor catalyst material selected from the group consisting of a metal, metal alloy, metal compound, and ceramic material. The method includes the steps of (a) providing an ionized arc nozzle comprising a consumable electrode, a non-consumable electrode, and a working gas flow to form an ionized arc between the two electrodes, wherein the consumable electrode provides the precursor catalyst material vaporizable therefrom by the ionized arc; (b) operating the arc nozzle to heat and at least partially vaporize the precursor catalyst material for providing a stream of nanometer-sized vapor clusters of the precursor catalyst material into a chamber in which the porous electrode substrate is disposed; and (c) introducing a stream of a carrier gas into the chamber to impinge upon the stream of precursor vapor clusters to produce depositable nano clusters which are carried by the carrier gas to deposit onto a first side of the porous electrode substrate for forming the nano-structured catalyst coating. Such a catalyst-coated electrode is particularly useful for fuel cell applications.

### FIELD OF THE INVENTION

The present invention relates to a gas diffusion electrode, a solid electrolyte membrane, a membrane electrode assembly (MEA), a fuel cell and a method for producing such an electrode, membrane, and MEA. In particular, the invention provides a method that is capable of mass-producing gas diffusion electrodes and solid electrolyte membranes containing high-utilization, nano-structured catalyst materials for fuel cell applications.

### BACKGROUND OF THE INVENTION

Several types of fuel cells have been developed to provide efficient sources of electrical power with reduced pollution. A particularly advantageous type is the proton exchange membrane (PEM) fuel cell. A PEM fuel cell typically is composed of, among other components, two gas diffusion electrodes (GDEs) with a PEM-electrolyte being sandwiched between these two GDEs. The use of a PEM fuel cell avoids the problems of handling liquid fuels and electrolytes because it uses gaseous reactants and a solid electrolyte that allows the transfer of protons between electrodes. PEM fuel cells have been found to be reliable, efficient and convenient sources of power. However, the current PEM fuel cells are very expensive in terms of cost per kilowatt of power delivered and, hence, their practical application has been limited to specialized applications that can justify their relatively high costs, e.g., in aerospace applications. If such fuel cells are to become more widely accepted, for example as sources of vehicle power or for use in stationary power plants, the cost in terms of dollars per delivered kilowatt will have to be significantly reduced.

A major factor in determining the cost of a PEM fuel cell is the cost of the electrodes, which is, in turn, determined by a number of factors, including primarily (1) the high cost of the precious metal catalysts, which are needed for practical efficiency and (2) the cost of fabricating the electrodes, which typically involves a batch process. In addition, the cost of a fuel cell system is also indirectly affected by the electrochemical performance of the electrodes which determines the power density of the fuel cell, i.e., the power produced per unit area (e.g., kilowatts per square centimeter). It is the combination of these three factors (i.e. power density, catalyst loading, and system fabrication costs) that determines the ultimate cost per kilowatt of a complete fuel cell system. These three factors are addressed in the present invention.

A review of the prior art fuel cell technologies has indicated that current fuel cell electrodes have used unsupported platinum black, having a surface area of about 28 m²/g with a particle size of about 10 nanometers, at a catalyst loading of about 4 mg/cm² of electrode area (e.g., as disclosed in U.S. Pat. No. 4,876,115, issued in Oct. 24, 1989 to I. Raistrick). It is commonly believed in the fuel cell industry that the amount of precious metal such as platinum will have to be reduced substantially below 1 mg/cm² if PEM fuel cells are to become a widely used source of electric power.

As far as the factor of catalyst loading is concerned, it has been commonly known that the amount of precious metal catalyst can be reduced if the metal is present in a more finely divided form. For instance, electrodes using platinum supported on granular carbon particles have been used. Such supported platinum catalysts are typically prepared by chemical precipitation of the metal onto the granular support. The catalysts typically have a surface area of about 120 m²/g, with a particle size of about 2-2.5 nanometers and a catalyst loading of about 0.5 mg/cm². Although a reduced amount of the costly platinum catalyst is used in these electrodes, the power density obtained using such electrodes has remained unsatisfactory. Consequently, the cost of such a fuel cell system is still too high. The relatively poor performance, i.e., low power density, is believed to be due to an ineffective utilization of the catalyst because a substantial fraction of the platinum is not accessible to the reagents.

In U.S. Pat. No. 5,084,144, Vilambi-Reddy, et al. disclosed a method for depositing precious metal catalyst in finely divided form in a gas diffusion electrode. The method proposed by Vilambi-Reddy entails electrolytically depositing fine particles of a catalytic metal onto an un-catalyzed layer of carbon particles, which are bonded with a fluorocarbon resin and impregnated with a proton exchange resin. The gas diffusion electrodes prepared by Vilambi-Reddy, et al. contained about 0.05 mg/cm² of platinum as particles of about 3.5 nanometers in diameter having a surface area of about 80 m²/g. Such electrodes were found to function about as well as the electrodes using supported platinum with a loading of 0.5 mg/cm² of platinum. These electrodes achieved their improved mass activity, i.e., current per platinum weight, because the electrolytic process deposits the catalyst particles only at regions which are accessible by both electrons and ions in the fuel cell system. However, such improved mass activity does not compensate for the low catalyst loading provided by the process of Vilambi-Reddy, et al. Furthermore, the process of Vilambi-Reddy, et al. is tedious and expensive. As a consequence, the power density of such electrodes is still insufficient to permit the wide use of PEM fuel cells as sources of electric power.

Other attempts to reduce the costs of PEM fuel cells and to improve their performance have not been very successful. For instance, in U.S. Pat. No. 5,211,984 (May 18, 1993) M. Wilson claims that the electrode used contains supported catalyst with a loading of only 0.35 mg/cm² of platinum. But, due to the thick film (10 μm) and large platinum particles used, the catalyst efficiency has been less than satisfactory. Thick films and, hence, excessive amounts of catalyst particles are used in a membrane electrode assembly (MEA) disclosed by S. Swathirajan (U.S. Pat. No. 5,316,871). The dispersion of catalyst and carbon particles in such an assembly prepared by slurry layer pressing is not uniform, resulting in a reduced utilization efficiency of catalyst particles. In the MEA disclosed by Kosek, et al. (U.S. Pat. No. 5,523,177), the reduced (Pt—Ru)Oₓ catalyst particles are disposed across the electrode layer thickness. Such a configuration does not make efficient utilization of the catalyst particles. Furthermore, most of the prior art methods for MEA preparation produce only relatively thick MEA structures and, therefore, are not conducive to the fabrication of thin-film, integrated fuel cells. Most of the methods used are slow and/or batch processes that are expensive. For instance, the method for the electro-deposition of catalytic metals using pulsed electric fields is slow, tedious, and costly (e.g., as disclosed in U.S. Pat. No. 6,080,504 issued to E. Taylor on Jun. 27, 2000).

Accordingly, a need has continued to exist for a method of depositing catalytic metals or metal oxides in a gas diffusion electrode and/or PEM in desired amounts, while retaining the small particle size and electronic and ionic accessibility that provides high mass activity.

### SUMMARY OF THE INVENTION

A preferred embodiment of the present invention is a method for producing a thin coating of nano-structured catalytic material onto a porous substrate (a gas diffusion electrode). The method includes three primary steps: (a) providing an ionized arc nozzle comprising a consumable electrode, a non-consumable electrode, and a working gas flow to form an ionized arc between the consumable electrode and the non-consumable electrode, wherein the consumable electrode provides a precursor catalyst material (selected from the group consisting of a metal, metal alloy, metal compound, and ceramic material) vaporizable therefrom by the ionized arc; (b) operating the arc nozzle to heat and at least partially vaporize the precursor catalyst material for providing a stream of nanometer-sized vapor clusters of the precursor catalyst material into a chamber in which the porous electrode substrate is disposed; and (c) introducing a stream of a carrier gas into the chamber to impinge upon the stream of precursor vapor clusters to produce depositable nano clusters which are carried by the carrier gas to deposit onto a first side of the porous electrode substrate for forming the nano-structured catalyst coating.

If the carrier gas contains oxygen molecules, for instance, they will react with metal vapors to form nano-scaled oxide clusters. If other reactive gases, instead of oxygen, are used, other compound or ceramic than oxide clusters are formed to produce non-oxide nano-structured coatings. Instead, if non-reactive gases such as inert gases are introduced to impinge upon the stream of metal vapor clusters, metal-based catalytic coatings are produced.

In the first step, the method begins with feeding a precursor catalyst wire or rod of a pure metal, metal alloy, metal compound, or ceramic into the upper portion of a deposition chamber. The wire or rod is supported on the top surface of a consumable electrode. The leading tip of the wire or rod is exposed to an arc formed between the consumable electrode and a non-consumable electrode in the presence of a working gas flow and under a high-current condition. The arc will heat and vaporize the wire or rod tips to form nano-sized clusters of the catalyst precursor material. While the wire tip is being consumed by the arc, the wire is either continuously or intermittently fed into an arc zone so that the leading tip is maintained at a relatively constant position with respect to the arc flame tail. In one preferred embodiment, an oxygen-containing gas is introduced into the chamber to react with the metal vapor clusters for forming metal oxide clusters. In this case, the oxygen-containing gas serves to provide the needed oxygen for initiating and propagating the exothermic oxidation reaction to form the oxide clusters in the liquid or vapor state, which are then deposited onto the substrate to form a thin coating. Several transition metal oxides are known to be very effective catalyst. In another preferred embodiment, only inert gases are used as the carrier gas and the resulting nano-structured coating is a catalytic metal. If the precursor catalyst material is a metal compound or ceramic, the resulting catalytic coating is also a compound or ceramic. The precursor material can be a pure metal, a metal alloy, a metal compound, a ceramic material, or any combination thereof.

The present invention provides a low-cost method that is capable of readily heating up the wire to a temperature as high as 6,000° C. In an ionized arc, the precursor material is rapidly heated to an ultra-high temperature and is vaporized essentially instantaneously to form atomic-, molecular-, or nanometer-scaled vapor clusters. Since the wire or rod can be continuously fed into the arc-forming zone, the arc vaporization is a continuous process, which means a high deposition rate. The atomic-, molecular-, or nanometer-scaled vapor clusters of a metal, metal compound, or ceramic material are directed to optionally pass through a heat treatment zone in such a fashion that individual clusters are deposited and bonded to the porous electrode substrate on the first face (catalyst-receiving surface facing the arc) of the substrate. Nano-scaled catalyst clusters are also allowed to penetrate slightly into the thickness of the electrode substrate so that they are deposited at the internal walls of the pores just underneath the first face. This penetration is preferably less than half of the substrate thickness and, further preferably, less than a quarter of the substrate layer thickness.

The presently invented method is applicable to essentially all metallic materials, including pure metals and metal alloys. The precursor material can also be any metal compound or ceramic material that is vaporizable. Transition metal elements are commonly used ingredients in a catalyst system. In the practice of the present invention, the catalyst precursor material may contain at least one transition metal element selected from the group consisting of Groups IB (Cu, Ag, Au), IIB (Zn, Cd, Hg), IIIB (Sc, Y, La), IVB (Ti, Zr, Hf), VB (V, Nb, Ta), VIB (Co, Mo, W), VIIB (Mn, RE), VIII (Fe, Co, Ni, Ru, Rh, Pd, Os, Ir, Pt) elements of the Periodic Table of Elements.

In the case of a pure metal or metal alloy, the reactive gas is preferably an oxygen-containing gas, which includes oxygen and, optionally, a predetermined amount of a second gas selected from the group consisting of argon, helium, hydrogen, carbon, nitrogen, chlorine, fluorine, boron, sulfur, phosphorus, selenium, tellurium, arsenic and combinations thereof. Argon and helium are noble gases and can be used as a carrier gas (without involving any chemical reaction) or as a means to regulate the oxidation rate. Other gases may be used to react with the metal clusters to form compound or ceramic phases of hydride, oxide, carbide, nitride, chloride, fluoride, boride, sulfide, phosphide, selenide, telluride, and arsenide in the resulting coating if so desired.

If the reactive gas contains oxygen, this reactive gas will rapidly react with the metal clusters to form nanometer-sized ceramic clusters (e.g., oxides). If the reactive gas contains a mixture of two or more reactive gases (e.g., oxygen and sulphur), the resulting product will contain a mixture of oxide and sulphide clusters. If the metal composition is a metal alloy or mixture (e.g., containing both Pt and Ru elements) and the reactive gas is oxygen, the resulting product will contain ultra-fine Pt—Ru oxide clusters that can be directed to deposit onto a glass, plastic, metal, or ceramic substrate. At a high arc temperature, metal clusters are normally capable of initiating a substantially spontaneous reaction with a reactant species (e.g., oxygen). In this case, the reaction heat released is effectively used to sustain the reactions in an already high temperature environment.

The same deposition method can be used to deposit a thin layer of nano-structured catalytic material onto one face or two faces of a solid electrolyte membrane (e.g., a PEM in a PEM fuel cell or a solid oxide electrode in a high temperature fuel cell). The solid electrolyte membrane layer is preferably porous to allow a desired amount of depositable nano clusters to migrate into the mambrane.

The present invention also provides a porous gas diffusion electrode for a fuel cell. The electrode includes (a) a gas permeable electrically conductive porous substrate layer of a known thickness having a gas-receiving face and, opposite thereto, a catalyst-supporting face; and (b) a nano-structured catalyst coating supported on the catalyst-supporting face and including a catalytic material in finely divided form in electrical contact with the catalyst-supporting face and residing in a catalyst region less than half of the layer thickness into the substrate layer from the catalyst-supporting face. The catalytic material is present in the form of ultra-fine particles having diameter of from about 2.0 nanometers to about 10 nanometers and a catalyst loading of from about 0.1 mg/cm² to about 1.0 mg/cm². These nano-scaled particles of catalytic material are deposited by the presently invented method.

Advantages of the present invention are summarized as follows:

1. A wide range of metals (particularly, transition metals), metal compounds and ceramic materials can be used as the precursor material. Furthermore, a wide variety of metallic elements can be readily converted into nanometer-scaled ceramic or compound clusters for deposition onto a solid substrate. Many compounds and ceramic materials are known to be good catalysts. In addition to oxygen, partner carrier gas species may be selected from the group consisting of hydrogen, carbon, nitrogen, chlorine, fluorine, boron, sulfur, phosphorus, selenium, tellurium, arsenic and combinations thereof to help regulate the oxidation rate and, if so desired, form respectively metal hydrides, oxides, carbides, nitrides, chlorides, fluorides, borides, sulfides, phosphide, selenide, telluride, arsenide and combinations thereof. No known prior-art technique is so versatile in terms of readily producing so many different types of metallic, compound, or ceramic catalysts on a substrate.

2. In the case of a metal material, the metal composition can be an alloy of two or more elements which are uniformly dispersed. When broken up into nano-sized clusters, these elements remain uniformly dispersed and are capable of reacting with oxygen to form uniformly mixed oxide particles. No post-fabrication mixing treatment is necessary. Some bi-metallic catalysts are known to provide good catalytic effects.

3. The wire can be fed into the arc zone at a high rate with its leading tip readily vaporized. This feature makes the method fast and effective and now makes it possible to mass produce catalytic coatings on a substrate (either a gas diffusion electrode or a solid electrolyte membrane) cost-effectively. Both a catalytic electrode and a solid electrolyte layer can be made by using the same method.

4. The system needed to carry out the invented method is simple and easy to operate. It does not require the utilization of heavy and expensive equipment such as a laser or vacuum-sputtering unit. In contrast, it is difficult for a method that involves a high vacuum to be a continuous process. The over-all product costs produced by the presently invented vacuum-free method are very low.

### BRIEF DESCRIPTION OF THE DRAWINGS

FIG. 1 schematic of a fuel cell composed of a gas-diffusing anode 10 (containing a thin layer 16 of electro-catalyst), an electrolyte layer 14, a gas-permeable cathode 12 (containing an electro-catalyst layer 18).

FIG. 2 schematic of another fuel cell in which the electrolyte layer 14 includes two thin layers of electro-catalyst deposited from its two major surfaces inward.

FIG. 3 shows the schematic of a system that can be used in the practice of a preferred embodiment of the presently invented method for producing oxide coating on a substrate.

FIG. 4 shows the schematic of another system (a multi-arc system) that can be used in the method for producing oxide coating on a substrate.

FIG. 5 schematically shows one way to prepare a membrane electrode assembly (MEA). (A) a solid electrolyte or electrolyte-separator layer, (B) one side 32 of this electrolyte layer is exposed to depositable catalytic clusters, (C) another side 34 of this electrolyte layer is exposed to depositable catalytic clusters, and (D) the resulting catalyst-bearing electrolyte layer is laminated with a fuel gas permeable electrode 35 and an air permeable electrode 36 to form a membrane electrode assembly.

### DETAILED DESCRIPTION OF PREFERRED EMBODIMENTS

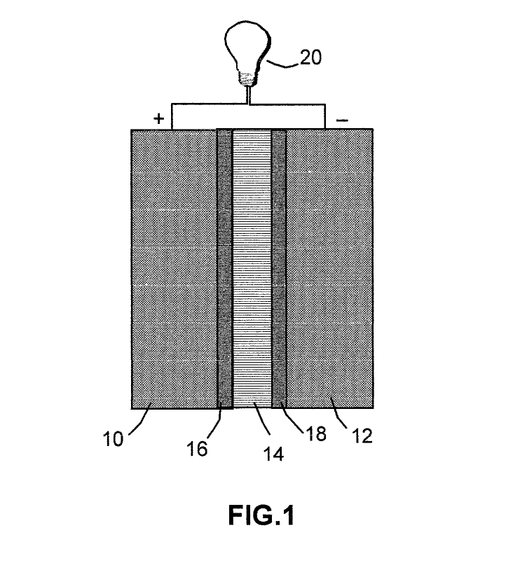

FIG. 1 schematically shows, as a preferred embodiment of the present invention, an example of fuel cells. This example is a proton exchange membrane (PEM) fuel cell that is composed of a gas-permeable or gas diffusion anode 10 (containing a thin layer 16 of electro-catalyst), a PEM-based electrolyte layer 14, and a gas-permeable cathode 12 (containing an electro-catalyst layer 18). Fuel gases (e.g., hydrogen) that enter from the anode 10 undergo an anode reaction (H₂→2H⁺+2e⁻) under the catalytic action of the electro-catalyst 16. The produced electrons go out to power an external load (e.g., a bulb 20). The produced protons H⁺ migrate into or through the proton exchange membrane and react with oxygen (that comes in from the cathode 12) to produce water molecules (½O₂+2H⁺+2e⁻→2H₂O). This cathode reaction is catalyzed by the electro-catalyst 18 deposited onto or into a surface of the cathode. The two catalyst layers 14,16 are prepared by a method to be described later. In FIG. 1, the catalyst layer (14 or 16) is preferably less than ½ and further preferably less than ¼ of the corresponding gas-diffusion electrode layer thickness.

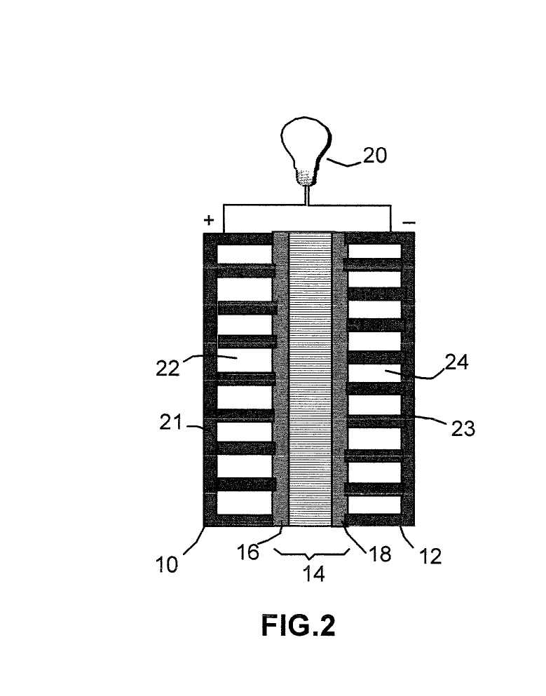

FIG. 2 schematically shows another example of fuel cells. The anode 10 has fuel flow channels (e.g., 22) that direct fuel gases to flow through an electro-catalyst layer 16, which may be considered a part of the electrolyte layer 14. In other words, the catalytic material is allowed to permeate into the bulk of the electrolyte layer during the catalyst deposition step. This penetration of the catalyst into the electrolyte is preferably less than ½ and further preferably less than ¼ of the electrolyte layer thickness. The anode 10 has a current collector plate or grid 21 which is electronically conducting. The cathode 12 has a current collector 23 and air flow channels (e.g., 24) that direct the migration of oxygen gases through an electro-catalyst layer 18, which serves to promote cathode reactions. In this case, the catalyst material in layer 18 resides in a sub-surface zone which is preferably less than ½ of the electrolyte layer thickness and further preferably less than ¼ of the electrolyte layer thickness.

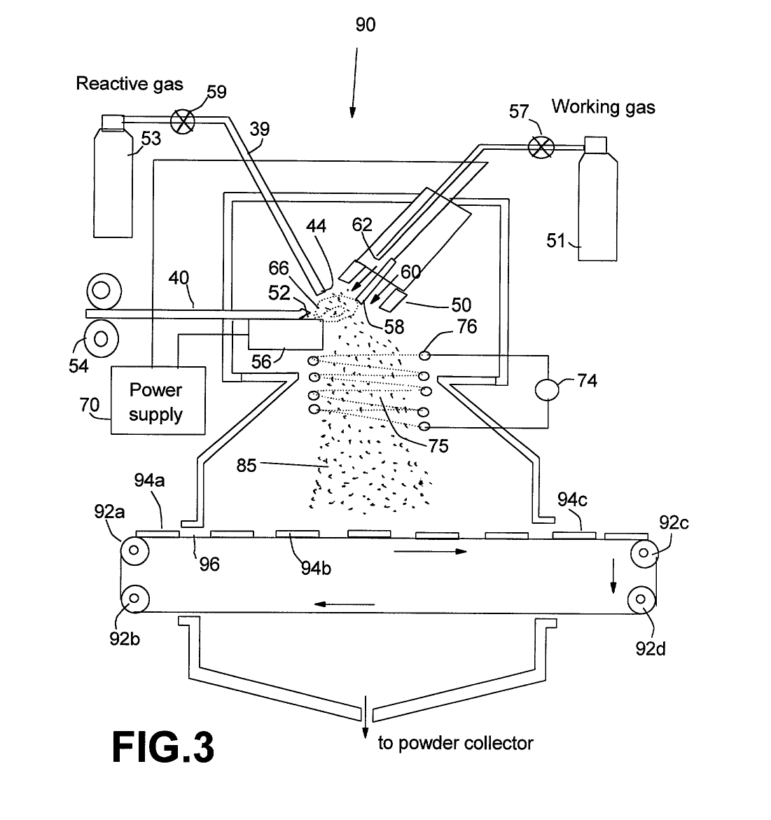

FIG. 3 schematically shows an arc-induced vapor cluster deposition system that can be used in practicing the method for producing a nano-structured catalyst coating onto a solid substrate such as a porous electrode and a solid electrolyte layer. This apparatus includes four major functional components: (1) a coating chamber 90, (2) an ionized arc nozzle 50 located at the upper portion of the chamber 90, (3) carrier gas-supplier (e.g., a gas bottle 53 supplying a reactive or inert gas through a control/regulator valve 57, pipe 39 and orifice 44 into a location inside the chamber in the vicinity of the ionized arc 66), and (4) substrate supporter-conveyor (e.g., conveying rollers 92a,92b,92c,92d and belt 96).

An example of the ionized arc-induced vapor cluster deposition system constructed in accordance with the present invention is shown in FIG. 3 The preparation of a thin, nano-structured catalyst coating begins with the vaporization of a catalyst precursor material 40 in the chamber 90 via an arc generated, for example, by a water-cooled tungsten inert gas torch 50 driven by a power supply 70. Although not a requirement, the interior of the chamber 90 is preferably maintained at a relative pressure of about 20 inches of mercury vacuum up to +3 psi positive pressure (absolute pressure 250 torr to 1000 torr).

The catalyst precursor material 40 is melted and vaporized by the transfer of arc energy from a non-consumable electrode 58, such as a thorium oxide-modified tungsten electrode. The non-consumable electrode 58 is shielded by a stream of an inert working gas 60 from a bottle 51 (through a gas control valve/regulator 57 and an orifice 62) to create the arc 66. The working gas 60 acts to shield the non-consumable electrode 58 from an oxidizing environment and then becomes a working plasma gas when it is ionized to a concentration large enough to establish an arc between the non-consumable electrode 58 and a consumable electrode 56.

The consumable precursor material 40 is preferably in the form of a rod or wire which has a diameter of typically from 0.1 mm to 5 mm and is fed horizontally relative to the non-consumable electrode 58. The feed wire or rod 40 of a precursor material (a metal, metal alloy, metal compound, or ceramic material) is continuously fed to maintain a stable arc and continuous production of nano-structured coatings. A continuous production is preferred over batch operation because the process can be run on a more consistent and cost-effective basis. The consumable electrode 56 is preferably water-cooled.

The non-consumable tungsten electrode 58 is preferably inclined at an angle with respect to the consumable electrode 56 so as to create an elongated arc flame 66. Depending on the current level, the arc flame 66 can be about one to several inches long. The arc flame 66 acts as a high temperature source to melt and vaporize the leading end 52 of the precursor material 40 to form a stream of vapor clusters that are atomic-, molecular, or nanometer-sized. A carrier gas (e.g. containing oxygen or a noble gas) is introduced from the bottle 53 through the orifice 44 into the arc 66. The amount of the carrier gas injected into the arc flame 66 is controlled by a gas flow meter-regulator 59. Preferably, a concentric gas injection geometry is established around the arc flame 66 to allow homogeneous insertion of the carrier gas. The carrier gas orifice 44 can be positioned at any point along the length of the arc flame 66 as shown in FIG. 3. The gas regulator or control meter valve 59 is used to adjust the gas flow rate as a way to vary the effective coating rate. The carrier gas serves to direct the precursor vapor clusters to flow toward the target substrate, which is either a porous substrate for the production of a catalytic gas diffusion electrode, or a solid electrolyte layer for the production of a catalytic solid electrolyte membrane. If containing a reactive gas such as oxygen, the carrier gas impinges upon the metal clusters to initiate and sustain an exothermic oxidation reaction between oxygen and precursor material clusters, thereby converting the ultra-fine clusters into depositable metal compound or ceramic clusters 85 that are in the liquid or, preferably, vapor state.

In an alternative embodiment of the presently invented method, a non-reactive gas or no gas is injected through orifice 44. In this case, the material composition of the resulting nano-structured coating will be the same as the precursor material. This is particularly useful for the deposition of noble metal catalyst from Pt and Au. A non-reactive gas may also be used to modulate or truncate the arc flame size, or simply to adjust the arc flame temperature.

The arc 66, being at an ultra-high temperature (up to 6,000° C.), functions to melt and vaporize the wire tip of the precursor material to generate nano-sized vapor clusters. A stream of working gas 60 from a source 51 exits out of the orifice 62 into the chamber to help maintain the ionized arc and to carry the stream of vapor clusters generally downward toward the lower portion of the coating chamber 90. Preferably, the working gas flow and the reactive gas are directed to move in a general direction toward the solid substrate (e.g. 94b) to be coated. In FIG. 3. as an example, this direction is approximately vertically downward.

The wire or rod 40 can be fed into the arc, either continuously or intermittently on demand, by a wire-feeding device (e.g., powered rollers 54). The roller speed may be varied by changing the speed of a controlling motor.

The ultra-fine vapor clusters 85 are then directed to deposit onto a solid electrode or electrolyte substrate (e.g., 94b) being supported by a conveyor belt 96 which is driven by 4 conveyor rollers 92a-92d. The lower portion of FIG. 3 shows a train of substrate glass pieces, including 94a (un-coated), 94b (being coated) and 94c (coated). Optionally, the chamber may be equipped with a heat treatment zone that serves to change the temperatures of the vapor clusters so that a desired proportion of the clusters remain in a vapor or liquid state. The temperature and physical state of the depositable clusters govern if these clusters are (a) deposited as individual nano particles that stick the substrate material at their points of contact or (b) spread up to become nano-sized thin film domains that partially cover the substrate. If so desired, the clusters with proper heat treatments (e.g., cooling) may become a mixture of solid particles and/or liquid droplets and/or vapor clusters prior to striking onto the substrate surface. The liquid droplets and/or vapor clusters act to glue or bond together otherwise separate individual solid particles, still leaving behind a desired amount of minute pores. Since the clusters are nanometer-scaled, the resulting pores are also nanometer-scaled. In the case when all clusters remain in the liquid or vapor state just prior to impinging upon the substrate, the resulting coating tends form relatively film-like, nano-scaled catalyst domains.

The vapor clusters that are not deposited onto a substrate will be cooled to solidify and become solid powder particles. These powder particles, along with the residual gases, are transferred through a conduit to an optional powder collector/separator system (not shown).

In another embodiment of the invented system, the wire or rod is made up of two metal elements so that a mixture of two types of nano clusters can be produced for the purpose of depositing a hybrid or composite catalyst material (e.g., a platinum-transition metal based bimetallic catalyst).

In a preferred embodiment, the system as defined above may further include a separate plasma arc zone below the ionized arc 66 to vaporize any un-vaporized material dripped therefrom. For instance, a dynamic plasma arc device (e.g., with power source 74 and coils 76 in FIG. 3) may be utilized to generate a plasma arc zone 75 through which the un-vaporized melt droplets dripped out of the ionized arc 66 will have another chance to get vaporized. The creation of a plasma arc zone is well-known in the art. The ultra-high temperature in the plasma arc (up to as high as 32,000° K) rapidly vaporizes the melt droplets that pass through the plasma arc zone.

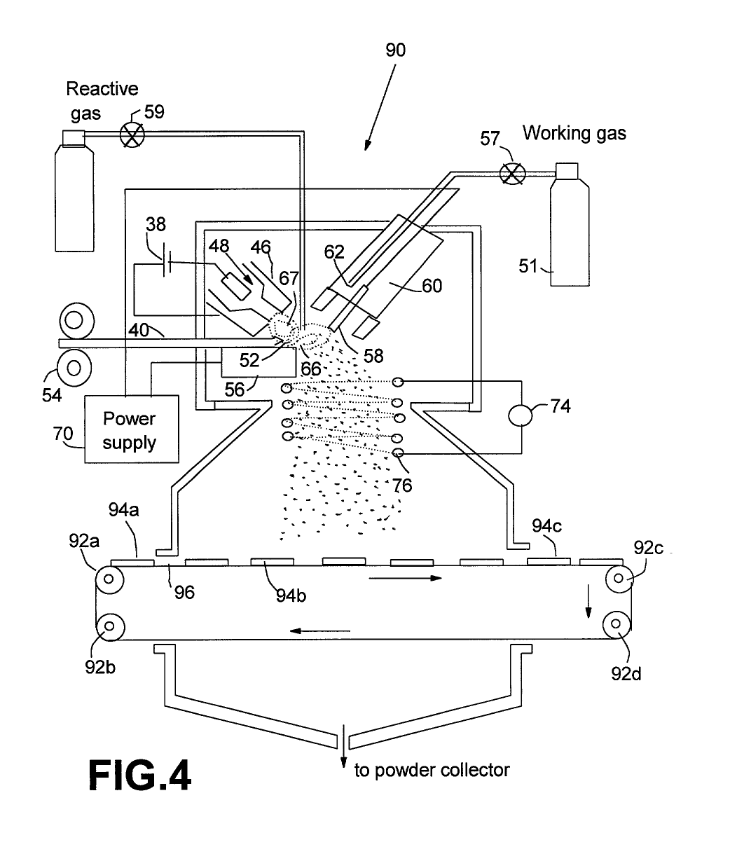

The ionized arc 66 tends to produce a metal melt pool or “weld pool” near the leading end 52 of the feed wire 40 on the top surface of the consumable electrode 56 if the arc tail temperature is not sufficiently high to fully vaporize the precursor material. The melt in this pool will eventually vaporize provided that an arc is maintained to continue to heat this pool. For the purpose of reducing the duration of time required to fully vaporize the metal material and, hence, increase the coating production rate, it is preferable to operate at least a second plasma or ionized arc nozzle to generate at least a second arc (e.g., 67 in FIG. 4) near the leading end 52 of the feed wire 40. For instance, shown in FIG. 4 is a DC plasma arc nozzle 46 which is driven by a DC power source 38 and a working gas flow 48 to create an arc 67 to provide additional heat energy to the precursor wire tip 52.

For the purpose of clearly defining the claims, the word “wire” means a wire of any practical diameter, e.g., from several microns (a thin wire or fiber) to several centimeters (a long, thick rod). A wire can be supplied from a spool, which could provide an uninterrupted supply of a wire as long as several miles. This is a very advantageous feature, since it makes the related coating process a continuous one.

The presently invented method is applicable to essentially all metallic materials (including pure metals and metal alloys), metallic compounds and ceramic materials. As used herein, the term “metal” refers to an element of Groups 2 through 13, inclusive, plus selected elements in Groups 14 and 15 of the periodic table. Thus, the term “metal” broadly refers to the following elements:

Group 2 or IIA: beryllium (Be), magnesium (Mg), calcium (Ca), strontium (Sr), barium (Ba), and radium (Ra).

Groups 3-12: transition metals (Groups IIIB, IVB, VB, VIB, VIIB, VIII, IB, and IIB), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), and mercury (Hg).

Group 13 or IIIA: boron (B), aluminum (Al), gallium (Ga), indium (In), and thallium (TI).

Lanthanides: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

Group 14 or IVA: germanium (Ge), tin (Sn), and lead (Pb).

Group 15 or VA: antimony (Sn) and bismuth (Bi).

For fuel cell applications where hydrogen splitting or oxygen catalyzing is needed, the group consisting of transition metals is most desirable. Noble metal elements such as Pt, Pd, and Au are very effective catalysts, so are most of the transition metal oxides.

Preferably the reactive gas includes oxygen and a gas selected from the group consisting of hydrogen, carbon, nitrogen, chlorine, fluorine, boron, iodine, sulfur, phosphorus, arsenic, selenium, tellurium and combinations thereof. Noble gases such as argon and helium may be used to adjust or regulate the oxidation rate. Other gases may be used to react with metal clusters to form nanometer-scale compound or ceramic powders of hydride, oxide, carbide, nitride, chloride, fluoride, boride, iodide, sulfide, phosphide, arsenide, selenide, and telluride, and combinations thereof. The method may further include operating means for providing dissociable inert gas mixable with the working gas. The dissociable inert gas serves to increase the temperature gradient in the ionized arc. The stream of reactive gas reacts with the vapor clusters in such a manner that the reaction heat released is used to sustain the reaction until most of the precursor vapor clusters are substantially converted to nanometer-sized metal compound or ceramic clusters. The stream of reactive gas is preferably pre-heated to a predetermined temperature prior to being injected to impinge upon the precursor vapor clusters. A higher gas temperature promotes or accelerates the conversion of metallic clusters to compound or ceramic clusters.

If the carrier gas injected contains a reactive gas (e.g., oxygen), this reactive gas will rapidly react with the precursor material clusters to form nanometer-sized ceramic clusters (e.g., oxides). If the reactive gas contains a mixture of two or more reactive gases (e.g., oxygen and sulphur), the resulting product will contain a mixture of two compounds or ceramics (e.g., oxide and sulphide). If the metal wire is a metal alloy or mixture (e.g., containing both nickel and copper elements) and the reactive gas is oxygen, the resulting product will contain ultra-fine nickel-copper oxide particles.

In summary, a preferred embodiment of the present invention is a method for producing a nano-porous catalyst coating onto a solid substrate such as a fuel cell electrolyte or electrode. The method includes the following steps: (a) providing an ionized arc nozzle that includes a consumable electrode, a non-consumable electrode, and a working gas flow to form a first ionized arc between the two electrodes, wherein the consumable electrode provides a precursor material vaporizable from the consumable electrode by the ionized arc; (b) operating the arc nozzle to heat and at least partially vaporize the precursor material for providing a stream of nanometer-sized vapor clusters into a chamber in which the substrate is disposed; (c) introducing a stream of gas (reactive, non-reactive, or both) into the chamber to impinge upon the stream of precursor vapor clusters and exothermically react therewith to produce substantially nanometer-sized metal compound or ceramic clusters (e.g., oxide clusters, if oxygen exists); and (d) directing the clusters to deposit onto (and slightly into) the substrate for forming the nano-porous catalyst coating.

Optionally, the method may include another step of operating a plasma arc means (e.g., a dynamic plasma device including a high-frequency power source 74 and coils 76) for vaporizing any un-vaporized compound or ceramic clusters or droplets after step (c) and before step (d). Also optionally, the method may include an additional step of operating at least a second ionized arc means (e.g., a DC plasma arc nozzle 46 in FIG. 4) for vaporizing any un-vaporized precursor material after step (b) or metal compound or ceramic clusters after step (c) but before step (d).

The optional step of operating heat treatment means may include a step of injecting a stream of cool gas (e.g., from gas cylinder 30 and exiting at 32) to impinge upon the vapor clusters in such a fashion that a non-zero proportion of the vapor clusters are converted into solid clusters being at a temperature sufficient to cause partial sintering between individual solid clusters. The step of operating heat treatment means may be carried out in such a fashion that the vapor clusters are converted to become a mixture of solid clusters and liquid clusters or a mixture of solid, liquid, and vapor clusters. The resulting catalyst coatings obtained under these conditions were found to be nano-grained and nano-porous.

In the presently invented method, the step of operating an arc nozzle means to heat and at least partially vaporize the wire of a precursor composition may include a sub-steps of melting the wire and atomizing the resulting metal melt to form nanometer-scaled liquid droplets of the precursor material. The liquid droplets are mixed with or become a part of the stream of vapor clusters. Atomization produces ultra-fine droplets that promote vaporization of the precursor material melt and accelerate the reaction between the precursor material and the reactive gas injected into the arc zone. Gas atomization, ultrasonic atomization, magnetic field blowing, etc. may be used to achieve the break-up of a weld pool into an aerosol of liquid droplets. The liquid droplets readily react with the reactive gas to form nano-scaled metal compound or ceramic clusters.

Preferably, the solid substrate in the practice of the present method includes a train of individual pieces of an electrode or electrolyte solid being moved sequentially or concurrently into coating chamber and then moved out of the chamber after the coating is formed. This feature will make the process a continuous one.

In a preferred embodiment of the present invention, an electrode (e.g. cathode) may contain a porous gas diffusion layer that comprises carbon and/or oxide particles. These particles may be bonded together by a resin or adhesive to form a porous structure. These carbon and/or oxide particles may be bonded to a fibrous substrate such as a non-woven fabric.

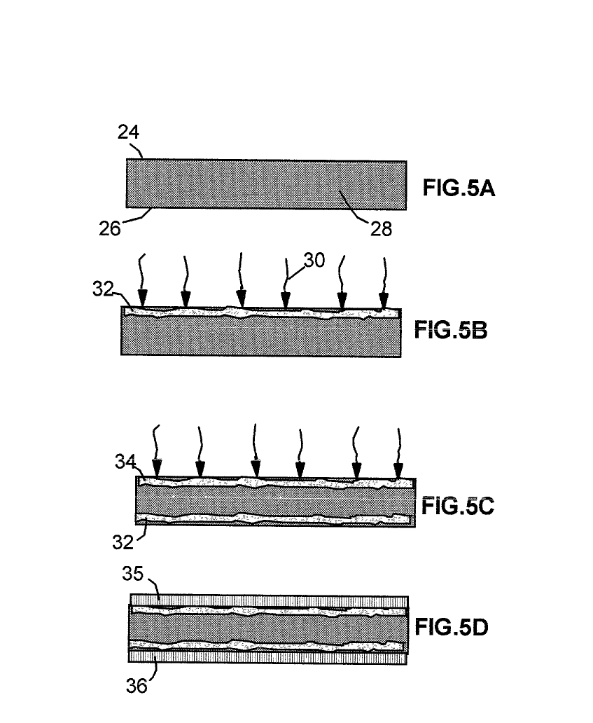

In a further preferred embodiment, the solid electrolyte layer may comprise either a proton exchange membrane (PEM) for a PEM-based fuel cell or a solid oxide electrolyte phase for a high temperature solid oxide fuel cell. For instance, as schematically shown in FIGS. 5A-5D, a porous solid oxide electrolyte layer (28 in FIG. 5A) has two major surfaces: a first surface 24 and a second surface 26. The electrolyte layer may be placed in the deposition chamber (e.g., in FIG. 3) with the first surface 24 facing up to receive depositable clusters 30 which penetrate slightly into the bulk of the electrolyte layer to form a catalyst layer 32 (FIG. 5B). This is followed by turning the electrolyte layer upside down and depositing an electro-catalyst layer 34 to the second surface 26 of this solid electrolyte layer (FIG. 5C). This electrolyte layer is then sandwiched between two gas permeable electrodes 35 and 36 to form a membrane electrode assembly (MEA, FIG. 5D). One MEA or several MEAs may be combined with other components such as current collector grids and cell casing to form a fuel cell.

Another preferred embodiment of the present invention is a fuel cell membrane electrode assembly comprising an ion-conducting electrolyte membrane sandwiched between two electrodes wherein at least one of the electrodes is a porous gas diffusion electrode which contains a nano-structured electro-catalyst layer prepared by the presently invented vapor cluster deposition method. This nano-structured catalytic coating layer is in electric contact with an electrolyte membrane. Preferably, this membrane is a proton exchange membrane.

Still another embodiment is a fuel cell that contains at least one of the above-defined MEAs or one of the above-defined porous gas diffusion electrode bearing an electro-catalyst layer prepared by the presently invented vapor cluster deposition method.

In summary, a further preferred embodiment of the present invention is a catalytic solid electrolyte membrane for a fuel cell. This membrane is characterized by comprising: (a) an ion-conducting solid electrolyte substrate layer of a known thickness having a first face and, opposite thereto, a second face; and (b) a nano-structured catalyst coating supported on the first major face and comprising a catalytic material in finely divided form in electrical contact with the first face and residing in a catalyst region less than a quarter of the layer thickness into the substrate layer from the first face. Specifically, the catalytic material is present in the form of ultra-fine particles having diameter of from about 2.0 nanometers to about 10 nanometers and the catalyst loading of from about 0.1 mg/cm² to about 1.0 mg/cm². Preferably, this solid electrolyte membrane further comprises a catalyst coating supported on its second major face. These particles of catalytic material are deposited by the vapor cluster deposition method. These particles reflect the best utilization of catalyst materials.

### EXAMPLE 1

A metal rod of Cu, Fe, Ti, Ni, Pt or Au of ⅛ inches diameter was used as a precursor catalyst material disposed on a top horizontal surface of the consumable arc electrode. The non-consumable arc electrode, which was used as an arc cathode, was a material consisting of 2% thoriate dispersed in a matrix of W. This arc electrode was shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor catalyst material. The arc created a stream of metal vapor clusters of 1-200 g/hr while an argon flow of 10-1000 cfh was injected into the tail flame to carry the metal vapor clusters toward a non-woven carbon fiber layer (as a porous air-permeable fuel cell anode). The micro-structure of the resulting catalyst layer was typically characterized by catalyst particle sizes in the range of 1-50 nm.

### EXAMPLE 2

A metal rod of Cu, Fe, Ti, or Ni of ⅛ inches diameter was used as a precursor catalyst material disposed on a top horizontal surface of the consumable arc electrode. The non-consumable arc electrode (arc cathode) was a material consisting of 2% thoriate dispersed in a matrix of W. This arc cathode was shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor catalyst material. The arc created a stream of metal vapor clusters of 1-200 g/hr while an oxygen flow of 10-1000 cfh was injected into the tail flame to form oxide clusters of the starting metal. These oxide clusters were directed to deposit onto a porous copper plate to form a catalytic oxide layer therein. The micro-structure of the resulting catalyst coatings was typically characterized by particle sizes in the range of 1-50 nm. These transition metal oxide nano particles are effective fuel cell cathode catalysts.

### EXAMPLE 3

The same precursor catalyst metals and same deposition procedures as in EXAMPLE 2 were used to deposit an oxide based catalyst layer onto two major surfaces of a solid oxide electrolyte, which was yttrium oxide stabilized zirconium oxide (YSZ). This solid electrolyte layer was sandwiched between two porous electrodes that were composed of a mixture of YSZ and nickel metal to make a solid oxide fuel cell.

What is claimed:

1. A method for depositing a nano-structured catalyst coating onto a porous electrode substrate from a precursor catalyst material selected from the group consisting of a metal, metal alloy, metal compound, and ceramic material, said method comprising:
(a) providing an ionized arc nozzle means comprising a consumable electrode, a non-consumable electrode, and a working gas flow to form an ionized arc between said consumable electrode and said non-consumable electrode, wherein said consumable electrode provides said precursor catalyst material vaporizable therefrom by said ionized arc;
(b) operating said arc nozzle means to heat and at least partially vaporize said precursor catalyst material for providing a stream of nanometer-sized vapor clusters of said precursor catalyst material into a chamber in which said porous electrode substrate is disposed; and
(c) introducing a stream of a carrier gas into said chamber to impinge upon said stream of precursor vapor clusters to produce depositable nano clusters which are carried by said carrier gas to deposit onto a first side of said porous electrode substrate for forming said nano-structured catalyst coating.

2. A method for depositing a nano-structured catalyst coating onto a solid electrolyte membrane substrate from a precursor catalyst material selected from the group consisting of a metal, metal alloy, metal compound, and ceramic material, said method comprising:
(a) providing an ionized arc nozzle means comprising a consumable electrode, a non-consumable electrode, and a working gas flow to form an ionized arc between said consumable electrode and said non-consumable electrode, wherein said consumable electrode provides said precursor catalyst material vaporizable therefrom by said ionized arc;
(b) operating said arc nozzle means to heat and at least partially vaporize said precursor catalyst material for providing a stream of nanometer-sized vapor clusters of said precursor catalyst material into a chamber in which said solid electrolyte membrane substrate is disposed; and
(c) introducing a stream of a carrier gas into said chamber to impinge upon said stream of precursor vapor clusters to produce depositable nano clusters which are carried by said carrier gas to deposit onto a first side of said solid electrolyte membrane substrate for forming said nano-structured catalyst coating.

3. The method of claim 1 or 2, wherein said carrier gas comprises a reactive gas that reacts with said precursor vapor clusters for producing said depositable nano clusters which are metal compounds or ceramic materials.

4. The method as set forth in claim 1 or 2, further comprising a step of operating at least a second ionized arc nozzle means to completely vaporize said precursor catalyst material.

5. The method as set forth in claim 1 or 2, wherein said precursor material comprises at least one transition metal element selected from the group consisting of Groups IB, IIB, IIIB, IVB, VB, VIB, VIIB, and VIII elements of the Periodic Table of Elements, wherein said Group IB includes Cu, Ag, and Au; Group IIB includes Zn, Cd, and Hg; Group IIIB includes Sc, Y, and La, Group IVB includes Ti, Zr, and Hf; Group VB includes V, Nb, and Ta; Group VIB includes Co, Mo, W; Group VIIB includes Mn and Re; and Group VIII includes Fe, Co, Ni, Ru, Rh, Pd, Os, Ir, and Pt.

6. The method as set forth in claim 3, wherein said stream of reactive gas comprises a gas selected from the group consisting of hydrogen, oxygen, carbon, nitrogen, chlorine, fluorine, boron, sulfur, phosphorus, selenium, tellurium, arsenic vapor and combinations thereof.

7. The method as set forth in claim 1 or 2, wherein said carrier gas comprises an inert gas.

8. The method as set forth in claim 1 or 2, wherein said substrate comprises a train of individual pieces of porous electrode substrate material or solid electrolyte membrane material being moved sequentially or concurrently into said chamber and then moved out of said chamber after said coating is formed.

9. The method as set forth in claim 1, wherein said porous electrode substrate comprises a micro-porous metal or oxide structure that is electronically conducting.

10. The method as set forth in claim 2, wherein said solid electrolyte membrane substrate comprises a porous solid oxide structure or an ion exchange polymer that is ionically conducting.

11. The method as set forth in claim 1 or 2, wherein said precursor material comprises an alloy of at least two metallic elements.

12. The method as set forth in claim 1 or 2, wherein said stream of carrier gas contains a reactive gas that reacts with said precursor catalyst vapor clusters in such a manner that the reaction heat released is used to sustain the reaction until most of said precursor vapor clusters are substantially converted to nanometer-sized metal compound or ceramic clusters.

13. The method as set forth in claim 1 or 2, wherein said stream of carrier gas is pre-heated to a predetermined temperature prior to being injected to impinge upon said precursor vapor clusters.

14. The method as defined in claim 1 or 2, wherein the step of operating an arc nozzle means to heat and at least partially vaporize the precursor catalyst material to form a stream of precursor catalyst vapor clusters includes the sub-steps of melting the precursor catalyst material and atomizing the resulting metal melt to form nanometer-scaled liquid droplets of said precursor material, said liquid droplets becoming mixed with said stream of vapor clusters.

15. The method as defined in claim 14, wherein said liquid droplets react with said reactive gas to form nano-scaled metal compound or ceramic clusters.

16. A porous gas diffusion electrode for a fuel cell comprising:
(A) a gas permeable electrically conductive porous substrate layer of a known thickness having a gas-receiving face and, opposite thereto, a catalyst-supporting face;
(B) a nano-structured catalyst coating being supported on said catalyst-supporting face and comprising a catalytic material in finely divided form in electrical contact with said catalyst-supporting face and residing in a catalyst region less than half of the layer thickness into said substrate layer from said catalyst-supporting face;
wherein said catalytic material being present in the form of ultra-fine particles having diameter of from about 2.0 nanometers to about 10 nanometers and the loading of said catalyst being from about 0.1 mg/cm² to about 1.0 mg/cm², and
said particles of catalytic material having been deposited by the method of claim 1.

17. The porous gas diffusion electrode as defined in claim 16, wherein said catalyst region has a thickness in a range of from 0.05 micrometers to about 5 micrometers.

18. The porous gas diffusion electrode as defined in claim 16, wherein said catalyst loading is in a range of from about 0.1 mg/cm² to about 0.3 mg/cm².

19. The porous gas diffusion electrode as set forth in claim 16, wherein said catalytic material comprises at least one transition metal element selected from the group consisting of Groups IB, IIB, IIIB, IVB, VB, VIB, VIIB, and VIII elements of the Periodic Table of Elements, wherein said Group IB includes Cu, Ag, and Au; Group IIB includes Zn, Cd, and Hg; Group IIIB includes Sc, Y, and La, Group IVB includes Ti, Zr, and Hf; Group VB includes V, Nb, and Ta; Group VIB includes Co, Mo, W; Group VIIB includes Mn and Re; and Group VIII includes Fe, Co, Ni, Ru, Rh, Pd, Os, Ir, and Pt.

20. The porous gas diffusion electrode as defined in claim 16, wherein said gas permeable porous substrate layer comprises carbon and/or oxide particles.

21. A fuel cell membrane electrode assembly comprising an ion-conducting electrolyte membrane sandwiched between two electrodes wherein at least one of the electrodes is a porous gas diffusion electrode defined by claim 16 and said nano-structured catalytic coating is in electric contact with said electrolyte membrane.

22. The membrane electrode assembly as defined in claim 21, wherein said membrane is a proton exchange membrane.

23. A fuel cell comprising a porous gas diffusion electrode as defined in claim 16.

24. A catalytic solid electrolyte membrane for a fuel cell, said membrane comprising:
(A) an ion-conducting solid electrolyte substrate layer of a known thickness having a first face and, opposite thereto, a second face;
(B) a nano-structured catalyst coating supported on said first face and comprising a catalytic material in finely divided form in electrical contact with said first face and residing in a catalyst region less than a quarter of the layer thickness into said substrate layer from said first face;
wherein said catalytic material being present in the form of ultra-fine particles having diameter of from about 2.0 nanometers to about 10 nanometers and the loading of said catalyst being from about 0.1 mg/cm² to about 1.0 mg/cm², and
said particles of catalytic material having been deposited by the method of claim 2.

25. The catalytic solid electrolyte membrane as defined in claim 24, further comprising a catalyst coating supported on said second face of the solid electrolyte substrate layer.

26. A fuel cell membrane electrode assembly comprising an ion-conducting electrolyte membrane, defined in claim 24 or 25, sandwiched between two electrodes.

27. A fuel cell comprising a catalytic solid electrolyte membrane as defined in claim 24.
